(19) United States
(12) Patent Application Publication
(10) Pub. No.: US 2017/0037816 A1
(43) Pub. Date: Feb. 9, 2017

(54) VAPOR DESTRUCTION APPARATUS AND METHOD

(71) Applicant: BRB/Sherline, Inc., Coto de Caza, CA (US)

(72) Inventor: Drew Harris Sherline, Coto de Caza, CA (US)

(21) Appl. No.: 15/226,654

(22) Filed: Aug. 2, 2016

Related U.S. Application Data
(60) Provisional application No. 62/200,558, filed on Aug. 3, 2015.

(51) Int. Cl. F02M 26/36; F02M 26/37

(52) U.S. Cl. CPC F02M 26/36; F02M 26/37

(57) ABSTRACT

This disclosure includes methods of improving the efficiency of a degassing operation and can include directing exhaust gases created by an internal combustion engine to a Volatile Organic Compound storage tank to increase the pressure therein and can include imposing a variable load upon the internal combustion engine as it is typically used in the performance of degassing operations and can include coupling a crankshaft of the internal combustion engine to a secondary internal combustion engine.

### PRIORTIY

The present application claims the benefit of U.S. Provisional Application No. 62/200,558, filed Aug. 3, 2015, the disclosure of which is hereby incorporated by reference herein in its entirety.

### BACKGROUND

Field

The present disclosure relates to a system and method for controlling emission of Volatile Organic Compounds (VOCs) and, more specifically, to an improved system and method for controlling VOC emissions by combustion of such emissions in degassing system such as an internal combustion engine.

Description of the Related Art

The direct release of Volatile Organic Compounds into the atmosphere has been for some time now recognized as a primary contributing factor in affecting ozone levels in the lower atmosphere. The EPA has established standards for safe levels of ozone, and local air quality districts have implemented regulations and mandated control measures pertaining to the release of hydrocarbon vapors into the atmosphere, from operations such as soil remediation and storage tank inerting, and storage vessel loading and unloading; that have been identified as sources of hydrocarbon emissions responsible for impacting ozone levels.

The process of treating these vapors, through any of a variety of methods, is typically referred to as degassing; which is either the collection or on-site destruction of these vapors as an environmentally responsible alternative to their otherwise direct release into the atmosphere.

The internal combustion engine, as well as open-flare incinerator units, has been employed for several decades as a means of on-site destruction of these Volatile Organic Compounds by elemental combustion. The combustion process does give rise to the undesirable production of carbon monoxide and nitrogen oxides; however this has been accepted as a reasonable consequence for the nearly 99% efficiency in the destruction of hydrocarbon based VOC's. These consequential emissions are accepted, but tolerated only to a regulated extent, and are also a factor to be considered in engines and incinerators employed in vapor destruction applications.

Combustion efficiency is often of equal importance to that of volumetric throughput in internal combustion engines employed in vapor destruction applications. For example, many of the Volatile Organic Compounds being the subject of treatment were never intended for use as a motor fuel. At one extreme of the range are the lighter C2 through C7 aliphatic or branched hydrocarbons and their corresponding alcohols; that tend to exhibit lower heating values (btu/cu ft) yet higher octane ratings than their contrasting counterparts such as gasoline with a substantially higher heating value yet lower octane rating; rendering these later compounds more susceptible to abnormal combustion and undesirable emissions. This is a particular concern involving combustion within the internal combustion engine versus that of the open-flare incinerator type unit.

In the case of the open-flare incinerator type unit, all of the energy derived from the combustion process is emitted as thermal energy. In the case of the internal combustion engine, a certain portion of the energy is dissipated through the engine cooling system; however a considerable amount remains as mechanical energy at the end of the rotating crankshaft. The maximum achievable volumetric throughput of the internal combustion engine is limited by the amount of produced horsepower that can be put to use at the flywheel.

Various methods have been employed throughout the past in an effort to impose a load at the engine flywheel such to match the power output in an effort to provoke the engine to realize its ideal potential volumetric throughput. Amongst these methods, has been the coupling of external devices such as hydraulic pumps, roots blowers, electrical generators and others; in an endeavor to impose some means of load to the rotating crankshaft. One common shortfall in employing such devices, is that their operable range does not match the inherently wider operable range (RPM) of the internal combustion engine; and their employment has served either to limit the maximum RPM of the engine, or otherwise require complex gear reduction type drives necessary to keep the RPM of these ancillary driven loading devices within safe operating speeds.

### SUMMARY

The efficiency of a degassing operation may also depend on the source of the VOC's and the techniques used to remove the VOC's from the source and to introduce the VOC's to an internal combustion engine. The removal of gaseous VOC's from a storage tank may result in a decrease in pressure in the storage tank, which can impact the ability of the degassing system to remove and destroy remaining VOC's

Accordingly, an embodiment comprises a method of controlling emissions of VOC's. The method can include removing VOC's from a storage container, transporting the VOC's to an internal combustion engine as a fuel thereof, burning the VOC's in the engine as the fuel, and transporting exhaust gases produced by the burning of the VOC's to the storage container.

One embodiment comprises a system for controlling emissions of VOC's by combustion of the VOC's in an internal combustion engine. The system can include a storage container holding VOC's, an internal combustion engine, a first conduit extending from the storage container to the internal combustion engine, the first conduit configured to transmit VOC's from the storage container to the internal combustion engine, and a second conduit extending from the internal combustion engine to the storage container, the second conduit configured to transmit exhaust gases produced by the internal combustion engine to the storage container.

One embodiment comprising re-circulating exhaust created by a vapor destruction/degassing system back into a vapor space for the purpose of displacing VOC's stored in the vapor space. This method can enhance volumetric throughput efficiency by creating positive flow through the vapor space, and can improve the overall the vapor destruction/degassing process.

Certain embodiments can include a degassing system for controlling emissions of VOC's by combustion of said VOC's in an internal combustion engine comprises a primary internal combustion engine that is connected to a source of VOC's and comprises a crankshaft and a secondary internal combustion engine that also comprises a crankshaft that is coupled to the crankshaft of the primary internal combustion engine.

Certain embodiments can include a method of controlling emissions of VOC's in which VOC's are transported to a primary internal combustion engine as a fuel thereof, burning said VOC's in said engine as the fuel, and rotating a crankshaft of a secondary internal combustion engine with a crankshaft of the first internal combustion engine.

Certain embodiments can include a mobile anti-pollution apparatus, for the reduction of hydrocarbon emissions. The apparatus can include a mobile platform upon which is mounted an internal combustion engine, the system comprising a primary internal combustion engine that is connected to a source of VOC's and comprises a crankshaft and a secondary internal combustion engine that also comprises a crankshaft, wherein the crankshafts of the first and second internal combustion engines are coupled together.

Other embodiments and arrangements will be described below.

For purposes of summarizing the disclosure and the advantages achieved over the prior art, certain objects and advantages of the certain embodiments of the invention have been described in this application. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 is a schematic illustration a degassing system according to one embodiment.

FIG. 2 is a schematic illustration of a degassing system according to another embodiment.

FIG. 3 is schematic illustration of embodiment of FIG. 2 mounted on a mobile device and connected to storage tank.

FIG. 4 is a schematic illustration of a degassing system according to another embodiment.

FIG. 5 is a schematic illustration of a degassing system according to another embodiment.

### DETAILED DESCRIPTION OF THE PREFERRED EMBODIMENTS

As described herein, embodiments include improved systems and methods for degassing operations utilizing internal combustion engines. Some embodiments include improved systems and methods for degassing operations involving the removal of VOC's (or other gases or vapors) from a storage container or tank. One embodiment can include the use of exhaust gases produced by the internal combustion engine to increase the pressure in the storage container containing the gaseous VOC's.

In one embodiment, a degassing system can employ a conduit (e.g., a pipe or hose) extending from a storage container to an internal combustion engine to transmit VOC's to the internal combustions engine, and a second conduit (e.g., pipe or hose) extending from the internal combustion engine to the storage container containing the gaseous VOC's to introduce or recirculate exhaust gases into the storage tank, increasing the pressure in the storage tank and directing the gaseous VOC's towards the conduit (e.g., pipe or hose) extending from the storage container to the internal combustion engine.

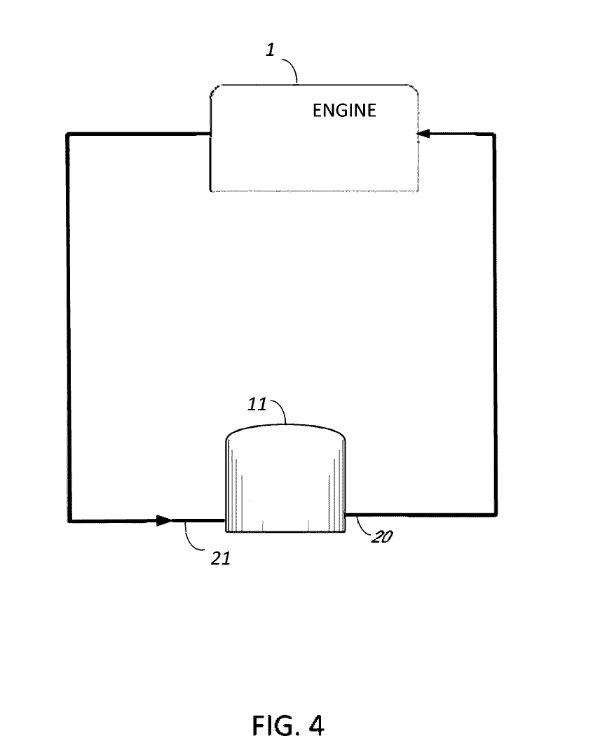

With reference now to FIG. 4, there is shown a system for degassing or removal of VOC's therefrom. The system can include a storage vessel 11, which can be any of a variety of storage vessels that may contain gaseous, Volatile Organic Compounds (VOC's) or other types of gases or vapors that can be removed from the storage vessel 11. The storage vessel 11 can be any of a variety of types of vessels such as an above ground storage tank, a storage tank on a vehicle, ship or air plane, an below ground storage tank etc. The methods and apparatuses described herein may also be used in other applications such as the degassing of pipelines or other vessels in which a degassing operation is desired. In the illustrated embodiment of FIG. 4, the gaseous, Volatile Organic Compounds (VOC's) (or other gases from the vessel 11) can be directed by a conduit (e.g., a piping or hose) 20 to the degassing system 2, which is illustrated as a single internal combustion engine in FIG. 4.

As described herein, the VOC's can be burned as fuel in the internal combustion engine 1, being converted from hazardous pollutants into carbon dioxide and water. In the embodiment of FIG. 4, the exhaust gases are directed by a conduit (e.g., a piping or hose) 21 to the storage vessel 11. In one embodiment, the exhaust gases can be introduced at a section of the storage vessel 11 opposite the opening of the pipe or hose 20. By introducing exhaust gases into the storage vessel 11, the pressure in the storage vessel 11 can be increased, which can cause the displacement of gaseous VOC vapors in the storage vessel 11 towards the opening of the pipe or hose 20 to facilitate the transmission of VOC's (or other gases/vapors) to the internal combustion engine 1.

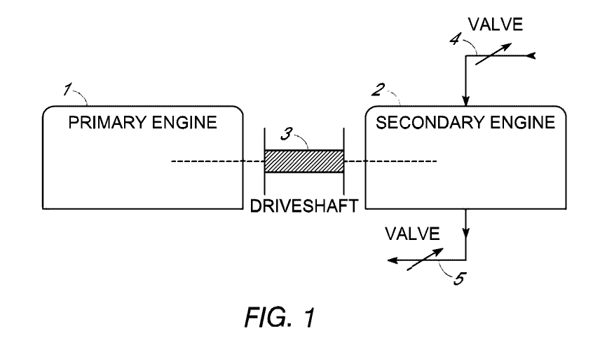

While the embodiment shown in FIG. 4 depicts a single internal combustion engine 1, it is contemplated that the efficiency of the degassing operation can be further improved by using methods of providing a load on the internal combustion engine such as those described herein. For example, it is contemplated that the degassing system illustrated in FIG. 4 can be replaced by any of the degassing systems depicted in FIGS. 1-3 and/or described herein. It is also anticipated that the degassing system illustrated in FIG. 4 can be used with other types of degassing systems besides internal combustion engines such as a thermal oxidizer. While not shown in FIG. 4, a three way valve or other valve structure can be provided between the engine 1 and the tank 11 to control rate of recirculation of exhaust into the tank 11.

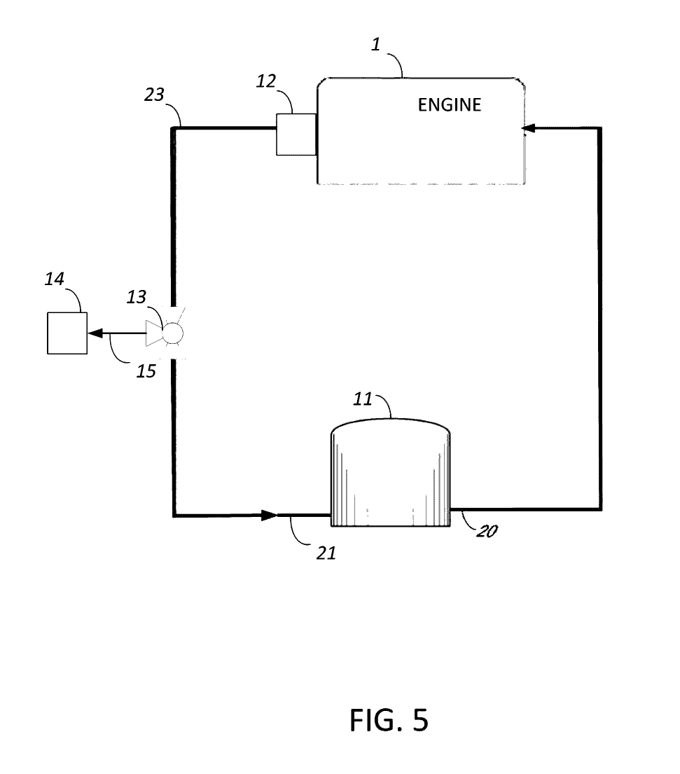

With reference now to FIG. 5, there is shown another embodiment of a system for degassing or removal of VOC's therefrom. This embodiment is similar to the embodiment of FIG. 4 and thus contains similar components identified by the same reference numbers but also illustrates a three-way valve 13 and treatment device 12 integrated into the system as will be described above. As with the embodiment of FIG. 4, the storage vessel 11 can be any of a variety of storage vessels that may contain gaseous, Volatile Organic Compounds (VOC's) or other types of gases or vapors that can be removed from the storage vessel 11. The storage vessel 11 can be any of a variety of types of vessels such as an above ground storage tank, a storage tank on a vehicle, ship or air plane, an below ground storage tank etc. The methods and apparatuses described herein may also be used in other applications such as the degassing of pipelines or other vessels in which a degassing operation is desired. In the illustrated embodiment of FIG. 5, the gaseous, Volatile Organic Compounds (VOC's) (or other gases from the vessel 11) can be directed by a conduit (e.g., a piping or hose) 20 to the degassing system 2, which is illustrated as a single internal combustion engine in FIG. 5.

As described herein, the VOC's can be burned as fuel in the internal combustion engine 1, being converted from hazardous pollutants into carbon dioxide and water. In the embodiment of FIG. 5, the exhaust gases are directed from the internal combustion engine 1 to a treatment device 12 for exhaust gases such as a thermo oxidizer unit, a catalytic converter and/or a 3-catalyst for treatment of the exhaust gases to create an inert gas stream. The exhaust gases can then directed by a conduit (e.g., a piping or hose) 23 to a three way valve 13. The exhaust gases can pass through the three way valve 13 into a conduit (e.g., a piping or hose) 21 in which the exhaust gases can be directed to the storage vessel 11. Exhaust gases can also pass through the three way valve 13 into a conduit 15. The exhaust gases can flow through the conduit 15 into an additional storage vessel 14 and/or discharged to atmosphere. The three way valve 13 can allow for control of the rate of recirculation of exhaust into the tank 11. While a three way valve is shown in FIG. 5, any suitable valve structure can be provided between the engine 1 and the tank 11 to control rate of recirculation of exhaust into the tank 11.

In the illustrated embodiment, the exhaust gases can be introduced at a section of the storage vessel 11 opposite the opening of the pipe or hose 20. By introducing exhaust gases into the storage vessel 11, the pressure in the storage vessel 11 can be increased, which can cause the displacement of gaseous VOC vapors in the storage vessel 11 towards the opening of the pipe or hose 20 to facilitate the transmission of VOC's (or other gases/vapors) to the internal combustion engine 1.

While the embodiment shown in FIG. 5 depicts a single internal combustion engine 1, it is contemplated that the efficiency of the degassing operation can be further improved by using methods of providing a load on the internal combustion engine such as those described herein. For example, it is contemplated that the degassing system illustrated in FIG. 5 can be replaced by any of the degassing systems depicted in FIGS. 1-3 and/or described herein. It is also anticipated that the degassing system illustrated in FIG. 5 can be used with other types of degassing systems besides internal combustion engines such as a thermal oxidizer.

An advantage of an embodiment of a system and method described herein is that the re-circulating exhaust can enhance the degassing process by creating positive pressure and turbulent flow for an overall push/pull effect through the storage vessel 11. Another advantage of such embodiments of the system and method described herein is that the re-circulating exhaust gas can also act as an inert gas blanket that can minimize or eliminate explosive limits during the degassing process and thus increasing the safety of the degassing process. Another advantage of such embodiments of the system and method described herein is that a large volume of inert gas is created during the process

In particular, when embodiments of the system and method descried above are used with embodiments of an internal combustion system such as embodiments of the internal combustion systems described herein with respect to FIGS. 1-3 and the corresponding primary and secondary internal combustions engines, the vapors from the storage vessel can be efficiently burned and then can also be and run through a 3-way catalyst, which can produce an inert gas stream that can displace the oxygen in the vapor space as the VOC's are being destroyed so that the explosion limit does not occur. Thus, embodiments of the system described herein can create an elegant solution for both increasing flow and optimizing safety in a degassing process. Another advantage of such embodiments of the system and method described herein is that a large volume of inert gas is created during the process as compared to degassing processes that do not use an internal combustion engine and/or that do not impose an effective load on the internal combustion engine as compared to the system described herein with respect to FIGS. 1-3.

As described herein, degassing operations is intended to be a broad term that can be generally defined as the destruction of Volatile Organic Compounds (VOC's), by elemental combustion, of hydrocarbon vapors emanating from, for example, soil remediation, in situ process streams, pipelines and storage vessels; as an environmentally responsible alternative to the otherwise direct release of these vapors into the atmosphere. In other embodiments, the degassing operations can also be applied to other compounds and/or from sources other than those listed herein.

As noted above, embodiments described above can also include and/or be used in combination with improved methods and systems of imposing a variable load upon the internal combustion engine as it is used in the performance of degassing operations. An example of such an improved method and apparatus is described in U.S. Pat. No. 8,936,011, the entirety of which is hereby incorporated by reference herein. Various embodiments of such improved methods and systems of imposing a variable load upon the internal combustion engine will now be described in detail below and with reference to FIGS. 1-3. However, it should be appreciated that while such improved methods and systems of imposing a variable load provide certain advantages (e.g., improved throughput), other embodiments may not include a variable load mechanism or the improved method and systems of imposing a variable load described in U.S. Pat. No. 8,936,011. For example, in some embodiments, the apparatus and process of recycling exhaust gases to the storage vessel can also be used with other vapor destruction systems such as internal combustion systems that do not utilize a secondary internal combustion as described herein or a thermal oxidizer.

One advantage of certain embodiments described below is that the system can allow an internal combustion engine to better realize its maximum volumetric throughput potential; but also can include a feature of adjustability that can allow for achieving optimum combustion efficiency in response to the unique combustion characteristics associated with the diverse range of VOC vapors being subject to treatment. In some embodiments, a more efficient method of introducing VOC's to the internal combustion engine is provided. In some embodiments, a more efficient method of providing a load on the internal combustion engine can be used in vapor destruction applications.

In one embodiment as noted above, a degassing system can employ a second internal combustion engine, coupled to a first internal combustion engine, to impose a resistive force in a counter rotative manner to the output of the first internal combustion engine; as a method of imposing a load equivalent to the output of the first internal combustion engine; enabling the first internal combustion engine to operate at or close to its full volumetric flow potential.

The ideal volumetric efficiency of the normally aspirated reciprocating type internal combustion engine is approximately 85% of its calculated displacement. A forced induction engine, depending upon its boost ratio, may perhaps be 120% of its calculated displacement. Both however face the problem that achievement of the full value of this volumetric displacement is dependent upon imposing a load equivalent to the horsepower being produced at the flywheel of the engine performing the vapor destruction operation.

Internal combustion engines typically used for the purpose of VOC destruction are capable of producing flywheel horsepower ratings in the neighborhood of 200 Hp. When perhaps only 50 Hp load is applied to these engines, it can be summarized that the engine can only be allowed to produce no more than this 50 Hp; and therefore (for example), a 500 cubic inch engine capable of a volumetric displacement of 500 cfm, is therefore only realistically capable of a maximum volumetric throughput of 125 cfm in actual service; or roughly 25% of its potential volumetric throughput.

As noted above, combustion efficiency is often equal concern to that of volumetric throughput in internal combustion engines employed in vapor destruction applications. Many of the Volatile Organic Compounds being the subject of treatment were never intended for use as a motor fuel. At one extreme of the range are the lighter C2 through C7 aliphatic or branched hydrocarbons that tend to exhibit lower heating values (btu/cu ft) yet higher octane ratings than their contrasting counterparts such as gasoline which exhibits a comparably higher heating value yet lower octane rating; rendering the later more susceptible to abnormal combustion if excessively loaded.

Certain embodiments described herein can apply the appropriate “loading” by employing a second internal combustion engine so arranged as to resist the normal rotation of the first. This can allow the primary (or first) internal combustion engine responsible for VOC destruction to operate at its maximum ideal volumetric throughput at any given RPM (or at least a larger range of RPM, and Applicant believes this affords a higher operating speed than current methods of loading allow, and affords also a degree of adjustability to the amount of this load at any given RPM to accommodate the unique combustion characteristics of the wide range of VOC's being the subject of treatment. An overall analysis is the conversion of rotational mechanical energy at the engine flywheel into thermal energy which is then dissipated to the atmosphere as simple heat by the secondary engine.

FIG. 1 is a schematic illustration of one embodiment of a degassing system that can be used in combination with the system of FIG. 4 described herein. In the illustrated embodiment, the engine housings of the primary engine (1) and the secondary engine (2) can be rigidly fixed in relation to each other. The independent crankshafts of each are directly coupled together by the intermediate drive shaft (3). In this arrangement, the two engines can be positioned back-to-back as the suggested method. Modified embodiments can include displacing the engine center lines axially and employing a cog-belt drive (or other intermediate member) between the two engines. Other modifications can include or the use of a gear reduction drive, and/or a shock absorbing type flexible coupling within the drive line. Additional and/or alternative modifications will be apparent to those of skill in the art for coupling secondary engine (2) to the primary engine (1) to impose the resistance offered by that of the secondary engine (2) on that of the power output of the primary engine (1). For example, in some embodiments a semi rigid or flexible coupling member can be used between the two engines.

In the illustrated arrangement, it is primarily the element of frictional horsepower of the secondary engine (2) which is being applied as resistance to the power output of the primary engine (1). For example, in the case of the typical 500 cubic inch engine, frictional horsepower alone can be as great as 200 horsepower. Frictional horsepower is of course based on the displacement size and particular engine, and tends to be a linear function of engine RPM.

In addition to frictional horsepower, there are pumping losses; induced by restriction of either the inlet (4) or outlet (5) of the secondary engine; which imposes an additional load, that is an adjustable load, independent of frictional horsepower and independent of RPM. This affords some degree of adjustability to the appropriate horsepower loading in response to the power output characteristics of different VOC□s at any given RPM; such that the maximum RPM and volumetric throughput can be maintained with minor variations in loading to accommodate the different heating value and combustion characteristics of different VOC's undergoing treatment.

Rigid coupling of crankshafts between the primary and secondary engine can be an elegant and effective embodiment. However, the internal combustion engine, whether serving as a driving or serving as a driven device, is by nature a pulsating device. So long as operation is relatively steady-state and the potential for imbalance is minimal, and, the rigid connection has been proven as a simple and effective arrangement. However, in cases where the potential for imbalance is a factor, and particularly if the operating RPM is non steady-state; this direct drive method has the potential to incur instantaneous shock loading that can be many times greater than the calculated steady-state load and can result in catastrophic mechanical failure.

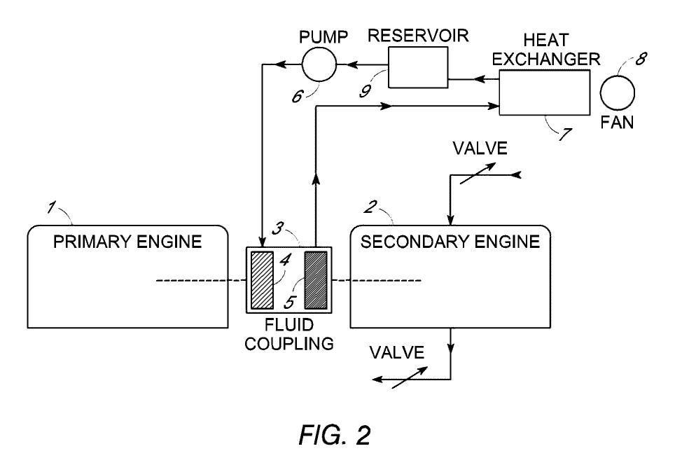

In applications wherein the above described issues are of a particular concern, the drive arrangement embodiment depicted in FIG. 2 can be utilized. FIG. 2 illustrates an arrangement; in which the drive shaft is of a more complex form, for example, in the illustrated arrangement the drive shaft incorporates a fluid coupling as method of power transmission

Referring to the illustrated embodiment FIG. 2, the primary engine (1) and the secondary engine (2) can be firmly positioned in fixed relation to each other. The independent crankshafts of each can be coupled by a fluid coupling assembly (3) that can incorporate an impeller as the driving torus (4) and a turbine as the driven torus (5) containing a hydraulic fluid medium. The transmission of power between the primary engine (1) and the secondary engine (2) can be accomplished through the hydraulic fluid medium circulated within the housing between the two torus members. In this embodiment, the assembly can resemble the form and function of a torque convertor as commonly found within the automatic transmission of the contemporary automobile.

The liquid hydraulic medium can be circulated by pump (6) at a pressure of approximately 100 psi into the torus members that are maintained full. The influx of hydraulic medium forces spent medium from the torus to the heat exchanger (7). The heat exchanger may be of the liquid-to-air type, wherein the hot hydraulic medium dissipates its heat to the atmospheric air circulated by fan (8); or may be of the liquid-to-liquid type wherein the hydraulic medium transfers its heat to a secondary liquid medium which is circulated by pump (8). The hydraulic reservoir (9) can allow for the thermal expansion of the liquid hydraulic medium and affords also the opportunity for any developed gas bubbles to coalesce from the liquid before being recirculated.

The selection of size, blade pitch, liquid medium and heat exchanger best suited for the particular application are straightforward engineering calculations known to those skilled in the art of power transmission and hydraulic engineering. As a brief overview: the starting point is to determine the amount of horsepower to be consumed at the flywheel of the power producing engine. This is a [FORCE×TIME] dimension, which is converted to convenient units of [BTU×TIME]. The selected liquid hydraulic medium, and the rate at which this is circulated through the system, should be sufficient to avoid the instantaneous superheating of the liquid hydraulic medium to its temperature of decomposition associated with the heat generated from being worked upon between the torus members. The sizing of the heat exchanger, whether the liquid-to-air type, or the liquid-to-liquid transfer to a medium such as running water; should be so sized that the [BTU×TIME] generated within the torus members is at least equaled and preferably exceeded by some margin such to return the circulated hydraulic medium to its ambient operating temperature. The volume of the hydraulic reservoir should be so sized as to accommodate the volumetric expansion of the hydraulic medium; but also to afford sufficient residence time for the coalescing of any accumulated gas bubbles before the medium is recirculated.

All of these calculations are within the realm of hydraulic engineer skilled in the art; and must be uniquely performed based upon the quantity of horsepower to be transferred at the flywheel of the power producing engine for the particular application.

It should be appreciated that while the illustrated embodiment utilizes a torque convertor as commonly found within the automatic transmission of the contemporary automobile, in other embodiments a different type of torque converter can be used, for example, a torque converter that utilizes magnets, gels, exotic materials etc.

An advantage of the embodiments described herein is that that the abundance of mechanical energy produced at the flywheel of the primary engine employed in vapor destruction applications is transferred to a secondary engine whereby it is consumed by frictional energy and transformed into thermal energy and finally dissipated to the atmosphere as simple heat energy.

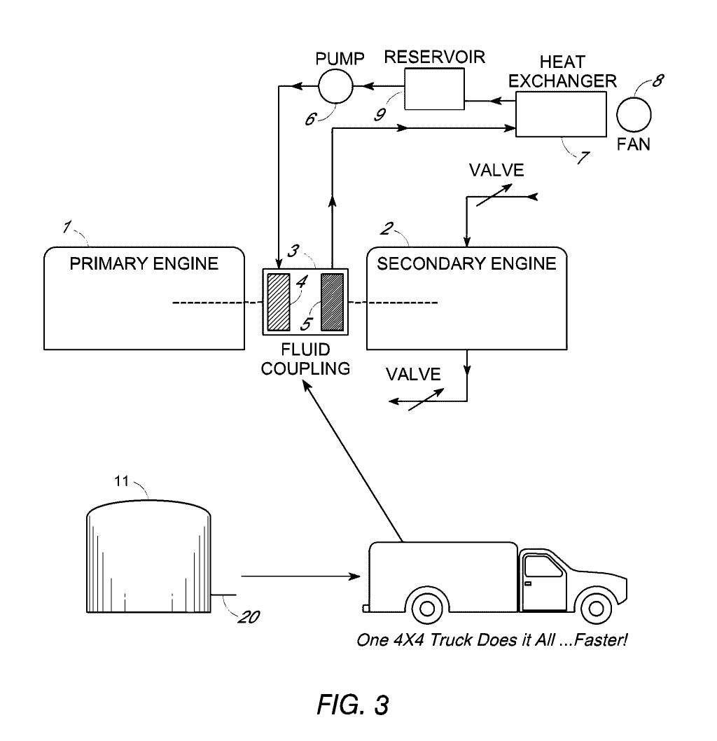

With reference now to FIG. 3, there is shown an above-ground storage tank 11 for degassing or removal of VOC's therefrom that can be used in combination with the system of FIG. 4. Degassing may occur before, during and/or after tank cleaning or during tank refilling. At noted above, it should also be understood that the systems and methods described herein can be utilized with other degassing or VOC removal operations. For example, they can be utilized for degassing underground storage tanks, barges, tankers, etc. They can also be utilized in controlling emissions from refineries and petrochemical processing facilities. They may also find utility in reducing other types of emissions besides VOCs.

In the embodiment of FIG. 3, the gaseous, Volatile Organic Compounds (VOC's) are directed by piping or hose 20 to the degassing system, which in the illustrated embodiment is the degassing system described with reference to FIG. 2. As shown in FIG. 2, the degassing system of the illustrated can made portable or mobile by mounting the device on a truck or similar device. In other embodiments, the degassing system can be stationary or semi-mobile. In some embodiments, a trailer, stationary frame or skid mount can be used to mount the device. When used in combination with the system of FIG. 4, second conduit can bused to direct the exhaust of the first internal combustion to the storage vessel that is storing the Volatile Organic Compounds (VOC's).

With reference to FIG. 3 above, in certain embodiments, a knock out drum (or similar device) for removing heavy liquid condensation, one or more air filters, flame arrestors and/or a turbo charger can be added upstream primary engine. In certain embodiments, a thermo oxidizer unit and/or a catalytic converter can be added to treat the exhaust downstream of the primary engine.

As described above, the VOC's can be burned as fuel in the primary internal combustion engine, being converted from hazardous pollutants into carbon dioxide and water. In some embodiments, the exhaust gases from the primary internal combustion engine can be directed then directed through piping (not shown), a catalytic converter (not shown) where any nitrogen oxides, carbon monoxides or other unwanted hydrocarbon products are converted to less hazardous gases for discharge as clean exhaust. In additional embodiments, additional or alternative emission abatement devices and/or additives can be added to the exhaust stream after the primary internal combustion engine and/or to the intake stream before the primary combustion stream. Moreover, as described herein with respect to FIG. 4 certain embodiments can include the use of exhaust gases produced by the primary internal combustion engine to increase the pressure in the storage container containing the gaseous VOC's by directing the exhaust gases from the primary internal combustion engine through a conduit (e.g., a pipe or hosing) to the storage vessel which is the source of eth VOC's that are being burned.

In one example mode of operation, the primary engine can be initially run on the VOC's from the tank 11 (or other source). Often the fuel mixture will be too rich and, in such cases, the mixture can be diluted with air. As the VOC's in the tank 11 (or other source) are consumed, the mixture may become lean at which time a supplemental fuel (e.g., methane, butane, natural gas, etc.) can be added to the intake mixture.

As described above, in the illustrated embodiments, the primary and secondary engines are reciprocating internal combustion engines. However, it is contemplated that other types of engines and/or internal combustion engines could be utilized in modified embodiments.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments can be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. A method of controlling emissions of VOC's, the method comprising removing VOC's from a storage container, transporting the VOC's to an internal combustion engine as a fuel thereof, burning the VOC's in the engine as the fuel, and transporting exhaust gases produced by the burning of the VOC's to the storage container.

2. The method of claim 1, further comprising introducing the exhaust gases to the storage container at a section of the storage container opposite a section of the storage container at which the VOC's are removed.

3. The method of claim 1, wherein as the engine burns VOC's as fuel, the engine rotates a crankshaft of a non-operating secondary internal combustion engine with a crankshaft of the engine so as to impose a variable load on the engine.

4. A system for controlling emissions of VOC's by combustion of the VOC's in an internal combustion engine, the system comprising a storage container holding VOC's, an internal combustion engine, a first conduit extending from the storage container to the internal combustion engine, the first conduit configured to transmit VOC's from the storage container to the internal combustion engine, and a second conduit extending from the internal combustion engine to the storage container, the second conduit configured to transmit exhaust gases produced by the internal combustion engine to the storage container.

5. The system of claim 4, wherein the first conduit is connected to a section of the storage container opposite a section of the storage container at which the second conduit is connected.

6. The system of claim 4, wherein the internal combustion engine comprises a crankshaft and the system further comprises a secondary internal combustion engine that also comprises a crankshaft, wherein the crankshafts of the internal combustion engine and second internal combustion engines are coupled together so the second internal combustion provides a resistive load on the internal combustion engine when the internal combustion engine is operating.

7. A method of controlling emissions of VOC's, the method comprising removing VOC's from a storage container, transporting the VOC's to an degassing system, reducing the VOC's in the degassing system, and transporting exhaust gases produced by the degassing system to the storage container.

8. A system for controlling emissions of VOC's by combustion of the VOC's in an internal combustion engine, the system comprising a storage container holding VOC's, a degassing system, a first conduit extending from the storage container to the degassing system, the first conduit configured to transmit VOC's from the storage container to the degassing system, and a second conduit extending from the internal combustion engine to the storage container, the second conduit configured to transmit exhaust gases produced by the degassing system to the storage container.
